(19) United States
(12) Patent Application Publication
(10) Pub. No.: US 2026/0177978 A1
(43) Pub. Date: Jun. 25, 2026

(54) WATCH WITH MECHANICAL MOVEMENT COMPRISING A ROTARY-CAGE REGULATOR

(71) Applicant: Glashütter Uhrenbetrieb GmbH, Glashütte/Sachsen (DE)

(72) Inventor: Matthias VILLING, Weil der Stadt (DE)

(73) Assignee: Glashütter Uhrenbetrieb GmbH, Glashütte/Sachsen (DE)

(21) Appl. No.: 19/414,708

(22) Filed: Dec. 10, 2025

(30) Foreign Application Priority Data
Dec. 19, 2024 (EP) 24221866.7

(51) Int. Cl. G04B 15/14; G04B 18/00; G04B 18/08

(52) U.S. Cl. CPC G04B 15/14; G04B 18/006; G04B 18/08

(57) ABSTRACT

A rotary-cage regulator (200) including a fixed wheel (1), a cage carrying a sprung balance, an escapement element (5) and an escapement wheel (4), the pinion (40) of which meshes with the fixed wheel (1), a lower cage (2) carrying teeth (22) and a locking element (21), a reloading wheel (61) attached to a spring (62) and pivoting on a bearing ring (3) fastened to a plate, a locking wheel (7) with teeth that can be stopped by the locking pallet stone (21). The assembly includes an epicyclic gear system, of which the cage (2) is the solar train, the ring (3) a satellite carrier, the reloading wheel (61) a first planetary gear and the locking wheel (7) a second planetary gear, arranged to release or lock the movement of the ring (3), and carrying a locking pinion (70) meshing with the fixed wheel (1).

### CROSS-REFERENCE TO RELATED APPLICATIONS

This application claims priority to European Patent Application No. 24221866.7 filed Dec. 19, 2024, the entire contents of which are incorporated herein by reference.

### TECHNICAL FIELD OF THE INVENTION

The invention relates to a mechanical horology movement comprising at least one rotary-cage regulator.

The invention also relates to a watch comprising at least one such movement.

The invention also relates to a horology assembly comprising at least one such watch and/or one such movement.

The invention also relates to a method for precision adjustment of the relative positions of a planetary locking wheel and of a locking pallet stone specific to the invention.

The invention relates to the field of mechanical watches comprising a tourbillon regulator, more specifically, a flying tourbillon.

### TECHNOLOGICAL BACKGROUND

The invention relates to a watch comprising a mechanical movement with a rotary-cage regulator. “Rotary-cage regulator” is taken to mean a system that causes a balance to rotate around an axis; tourbillons, and Bonikksen carrousels, fall into this category. More specifically, but not limitingly, the invention can be applied to a rotary-cage regulator which is a tourbillon, in particular a flying tourbillon, comprising a jumping-seconds display mechanism.

The proposed mechanism enables jumping seconds to be displayed on a mechanical watch fitted with a rotary-cage regulator, in particular a flying tourbillon.

“Dead-beat seconds” mechanisms have been known for centuries, and are designed to make it easier to read the exact seconds displayed by horology mechanisms.

Stationary-precision mechanical timekeepers generally use a “seconds pendulum” with an oscillation frequency of 0.5 Hz (that is, an oscillation period of two seconds or one second per half-oscillation or alternation). Most of the standard escapements used for precision pendulum clocks (such as the Graham/Riefler/Strasser escapement) impulse the oscillator once per half-oscillation, that is, twice per oscillation (equivalent to 3,600 vibrations per hour), the natural result of which is that the seconds hand jumps in one-second increments. Clocks with seconds pendulums were used as standard astronomical chronometers until the middle of the twentieth century to determine the times of celestial body transits.

The need for portable precision chronometers for navigation (see the British “Queen Anne Longitude Act” of 1714) led to the development of marine chronometers, which functioned with an oscillation frequency of 2 Hz (or 14,400 A/h) which, in combination with a chronometer escapement that gave an impulse to the balance only every two half-oscillations, that is, one impulse per oscillation, drove the seconds hand in half-second jumps.

However, pocket watches and wristwatches, which are much smaller than marine chronometers, would require higher-frequency oscillators to achieve similar precision (Q factor; nowadays, oscillation frequencies comprised between 2.5 and 5 Hz are generally used in wristwatch movements), resulting in smaller jumps by the seconds hand (with standard pallet escapements: 5 jumps per second at 2.5 Hz, and 10 jumps per second at 5 Hz).

It was therefore necessary to find other ways of achieving jumps in the seconds and half-seconds hands that were easier to read.

In the mid-eighteenth century, Jean Romilly was the first horologist to design a watch with a stoppable seconds hand and a balance oscillation frequency chosen to produce the jumping seconds.

Around 1776, Jean Moise Pouzait invented a seconds mechanism that could be started and stopped independently (“independent dead-beat seconds”). This mechanism required a secondary train with a “whip” that engaged in a “star” on the axis of the escapement wheel and was then released to rotate rapidly once a second. Document CH256885A granted to OMEGA describes such a mechanism. Such horology mechanisms had seconds hands that jumped in one-second increments (with higher-frequency oscillators and standard escapements).

Later designs did away with a large part of the secondary gear train by introducing an intermediate spring mechanism periodically rewound by the primary gear train.

With the advent of modern chronograph mechanisms with resettable seconds hands, these mechanisms have faded into obscurity, with a brief revival of permanently-functioning dead-beat seconds mechanisms in the 1950s and 1960s, such as the Omega Cal. 372 “Synchrobeat” calibre.

In recent years, there has been a renewed interest in jumping seconds mechanisms among connoisseurs of fine horology, with many examples incorporating a “remontoir d'égalité” with a one-second reloading interval for a jumping seconds hand. However, such a mechanism is in the energy flow between the barrel and the escapement, and the components must be dimensioned accordingly. Furthermore, it is difficult, if not impossible, to precisely set the timing of the jump on existing mechanisms.

### SUMMARY OF THE INVENTION

The invention aims to produce a new horology movement comprising a rotary-cage regulator, in particular a tourbillon regulator, in particular a jumping-seconds flying tourbillon regulator in which the mechanism is downstream of the escapement mechanism and in which the jump position can be set in the workshop.

The invention therefore relates to a mechanical horology movement comprising at least one rotary-cage regulator according to claim 1.

The invention also relates to a watch comprising at least one such movement.

The invention also relates to a horology assembly comprising at least one such watch and/or one such movement.

The invention also relates to a method for precision adjustment of the relative positions of a planetary locking wheel and a locking element specific to the invention.

### BRIEF DESCRIPTION OF THE FIGURES

The purposes, advantages and characteristics of the invention will become clearer from the following detailed description, with reference to the appended drawings, in which:

FIG. 1 illustrates a schematic perspective view of a rotary-cage regulator according to a particular variant of the invention, in the particular and non-limiting case of a jump-second flying tourbillon, which comprises a lower cage modified by the addition of two outwardly-protruding gear teeth carried by a substantially annular body, and of a locking pallet stone carried by an arm on this lower cage; the tourbillon also comprises a reloading wheel associated with a reloading spring, these two gear teeth being arranged to mesh with this reloading wheel; the reloading wheel is carried by a bearing ring, which also carries a planetary locking wheel; this locking wheel comprises locking teeth arranged to bear on the locking pallet stone in a lock position;

FIG. 2 illustrates a schematic top view, from the side visible to the user and opposite the plate of the movement comprising the tourbillon, of the lower part of the tourbillon in FIG. 1, with the upper cage, the balance spring assembly and the cock for hooking the balance spring not shown; the escapement wheel is visible at six o'clock, the pallet at five o'clock, the wheel and the balance spring at ten o'clock, as well as the gear teeth; one arm of the lower cage, at four o'clock, carries the locking pallet stone, the locking wheel is at three o'clock, a locking tooth can be seen bearing at rest on the support surface of the locking element, here non-limitingly a locking pallet stone, which extends substantially tangentially;

FIG. 3 illustrates an exploded schematic perspective view of all the components of the tourbillon in FIG. 1;

FIG. 4 illustrates a schematic top view, similar to FIG. 2, of all the components for setting the seconds jump of the tourbillon in FIG. 1: the lower cage overlaid on the fixed tourbillon wheel, the escapement mechanism in the left-hand part, the locking element and the locking wheel at six o'clock; the locking wheel comprises a pinion meshing with the fixed wheel; the gear teeth can be seen at one o'clock;

FIG. 5 illustrates a schematic partial view, similar to FIG. 4, of the end of the locking element, in a particular configuration in which the support surface of the locking teeth covers an angle at the centre of 1°, starting from the pivot axis of the cage; this angle is blanked into an integer number of sectors, in this case seven sectors, corresponding to as many potential lock positions of the distal end of the locking tooth on the locking wheel;

FIG. 6 illustrates a schematic top view, similar to FIG. 5, of a close-up of the engagement between the locking element and a locking tooth: on the left-hand side, whereas the relative orientation of the locking wheel relative to the imaginary line between its own centre and the centre of the fixed tourbillon wheel remains identical (except that it is offset by exactly one tooth in a clockwise direction), the locking teeth on the locking pinion are inclined by the difference between the values of the quotients of 360° by the number of teeth, on one hand the number of teeth on the planetary locking wheel, and on the other hand the number of teeth on the locking pinion, this difference having, in the particular example illustrated, an angular value of 20.5714° (between the tangency lines with the fixed wheel in dashed lines and in continuous lines), relative to their original orientation. The right-hand side of the figure shows how the locking pinion rolls along the fixed wheel, rolling on its teeth, in order to restore correct meshing between its own teeth and the teeth on the fixed wheel; with the particular gear ratio of the illustrated example, the 20.5714° rotation of the locking pinion around its axis corresponds to a pivot of 1.71429° around the central axis of the tourbillon;

FIG. 7 illustrates a partial schematic view of a close-up of FIG. 2, illustrating means for adjusting the position of the seconds hand;

FIG. 8 illustrates a schematic exploded perspective view of the close-up illustrated in FIG. 7;

FIG. 9 illustrates a schematic perspective view similar to FIG. 1, of the use of an eccentric tool to set the angular position of the fixed wheel relative to the seconds dial;

FIG. 10 shows the top view of FIG. 9;

FIG. 11 shows a schematic front view of a watch comprising a movement fitted with a rotary-cage regulator, in particular a tourbillon, according to the invention;

FIG. 12 is a flow chart showing the steps in a method for precision adjustment of the relative positions of the planetary locking wheel and of the locking element.

### DETAILED DESCRIPTION OF THE INVENTION

The invention relates to a mechanical horology movement 1000 comprising a mechanism that enables the dead-beat second to be displayed on a mechanical watch 2000 fitted with a rotary-cage regulator 200, in particular a flying tourbillon.

The proposed and illustrated mechanism is based on the flying tourbillon with balance stop device described in document CH717982 granted to GLASHUETTE ORIGINAL, incorporated herein by reference.

This mechanical horology movement 1000 comprises at least one rotary-cage regulator 200 comprising a fixed wheel 1, a cage (comprising, in the particular preferred variant illustrated in the figures, at least a lower cage 2 and an upper cage 11) carrying a sprung balance comprising a balance 60 and a main balance spring 90, an escapement element 5 (or more specifically a pallet in the example illustrated), and an escapement wheel 4 in which the escape pinion 40 meshes directly or indirectly with the fixed wheel 1, and more specifically directly in the particular preferred variant illustrated in the figures. In other variants, there is an intermediate mobile between this escapement pinion 40 and the fixed wheel 1, as is the case, for example, in a Bonniksen karussel mechanism in which the escapement pinion is arranged by a mobile wheel, or, in a five-minute tourbillon, an intermediate mobile is inserted between the escapement wheel and the fixed wheel.

The cage also carries a locking element 21, as well as a bearing fastened to a movement plate 100 coaxially to the cage.

According to the invention, the rotary-cage regulator 200 comprises a locking wheel 7 with locking teeth 71, pivoting on a bearing ring 3. These locking teeth 71 can be stopped by this locking element 21 with a lock position that can be set in the workshop. The locking wheel 7 is arranged to release or lock the movement of the ring 3, and carries a locking pinion 70 permanently meshing with said fixed wheel 1. And the ring 3 is connected to the rotary-cage regulator 200 by an intermediate reloading system, which winds a reloading spring 62 via the movement of the rotary-cage regulator 200 such that the reloading spring 62 maintains the movement of the ring 3 in the same direction of rotation as the rotary-cage regulator 200 as it lets down.

It should be understood that the nature of the escapement element 5 depends on the type of escapement used, since the invention can be used for any type of escapement mechanism, whether pallet, detent, duplex, cylinder, gathering pallet, Graham or other. The invention is non-limitingly illustrated in the particular example of a pallet escapement mechanism, and the escapement element 5 is more specifically but not limited to a pallet.

According to the particular variant of the invention illustrated in the figures, the lower cage 2 carries gear teeth 22 and a locking element 21 or, as illustrated in the figures, a locking pallet stone. The rotary-cage regulator 200 further comprises a reloading wheel 61 attached to a reloading balance spring 62 and pivoting on a ring 3 on a bearing fastened to a plate on the movement 1000 (by its inner ring), and a locking wheel 7 with locking teeth 71 that can be stopped by the locking element 21 with a stop position that can be set in the workshop, the assembly consisting of a first epicyclic gear system in which the lower cage 2 is the solar train and the ring 3 on the bearing is a satellite carrier in which the reloading wheel 61 is a first planetary gear. The locking wheel 7 is arranged to release or lock the movement of the ring 3, and carries a locking pinion 70 permanently meshing with the fixed wheel 1.

The locking element 21 can have different forms and be fastened in different ways to different components of the mechanism; for example, a pin protruding from the upper cage 11 of the oscillating system would also function as described hereinafter.

The reloading system described above with the epicyclic gearing between the teeth 22 on the lower cage 2 of the tourbillon and the reloading wheel 61 with its reloading spring 62 in the form of a balance spring is a particularly compact variant; but for example a leaf spring fastened by a first end to the cage of the tourbillon, and by a second end to the satellite carrier (the ring 3) is also suitable.

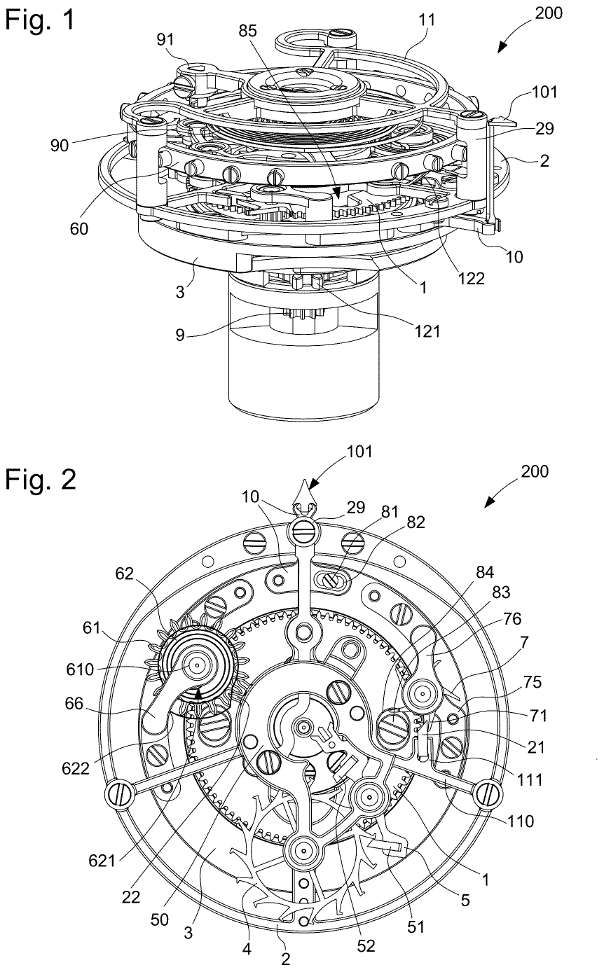

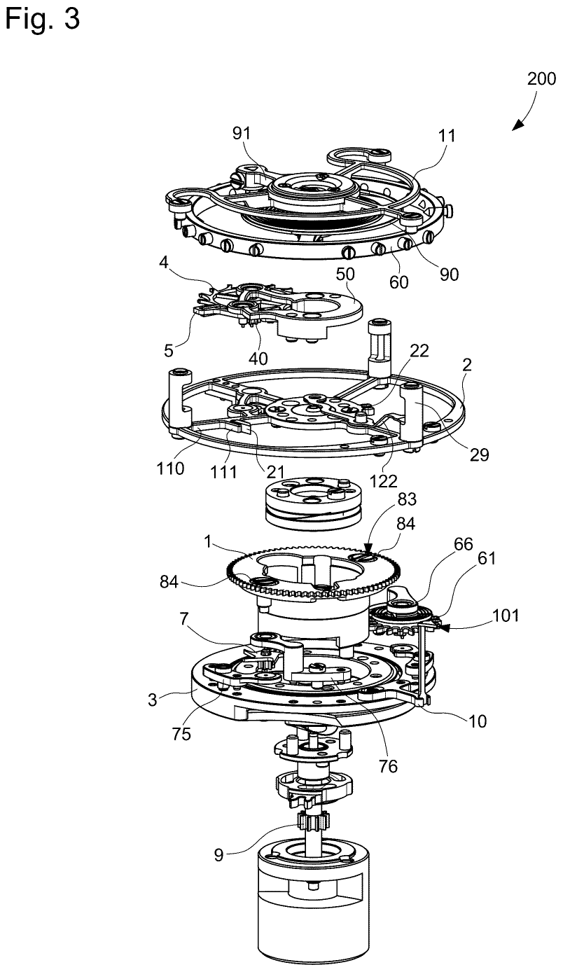

FIGS. 1 to 3 illustrate a perspective view, a top view, and an exploded view of such a rotary-cage regulator 200 according to the invention.

More specifically, this rotary-cage regulator 200 comprises a pivoted cage, comprising a lower cage 2 and an upper cage 11, non-limitingly connected by three pillars 29. The cage carries a sprung balance assembly comprising a balance 60 and a main balance spring 90 attached to a stud 91 on a bar. This cage is fastened to the axis of the pignon de seconde 9, which is arranged to drive the motion work.

The cage carries the escapement mechanism, which comprises an escapement wheel 4, with a number of teeth N4, which is arranged to engage with an escapement element 5, in this case, but not limited to, a Swiss pallet with two pallet stones 51 and 52. The escapement wheel 4 and the escapement element 5 are both pivoted at the top in a bar 50.

The tourbillon comprises a fixed wheel 1, fastened to the plate, which comprises outer toothing with a number of teeth N1.

The escapement wheel 4 is attached to an escapement pinion 40, with a number of teeth N40, which meshes with the toothing on the fixed wheel 1.

With regard to this known mechanism, according to the invention the lower cage 2 of the rotary-cage regulator 200 is modified by the addition of two outwardly-protruding gear teeth 22 and a locking element 21 (or a locking pallet stone), in particular made of ruby, carried by an arm 110 of the lower cage 2 in a bed 111.

More specifically, the tourbillon comprises a reloading wheel 61, carried by an upper pivot 610 on a first cock 66, and associated with a reloading spring 62. More specifically, this reloading spring 62 is attached at its outer end 622 to the first cock 66 and at its inner end 621 to the reloading wheel 61.

The two teeth 22 are arranged so as to mesh with this reloading wheel 61.

More specifically, the tourbillon also comprises a planetary locking wheel 7, comprising N7 locking teeth 71, and which is carried by a support 75 and a second cock 76, between which it is fitted so as to pivot. And the locking element 21 is arranged to engage in contact with a locking tooth 71 on this planetary locking wheel 7.

The reloading wheel 61 and the planetary locking wheel 7 are both fitted so as to pivot apart from each other on the outer ring 3 of a ball bearing that is coaxially fastened under the lower cage 2 of the rotary-cage regulator 200.

While the ball bearing 3 is immobile, the reloading spring 62 is thus rewound by the moving tourbillon via the meshing between the two teeth 22 on the lower cage of the tourbillon 2 and the reloading wheel 61.

The tension of the reloading spring 62 will enable the entire outer ring 3 on the ball bearing to rotate in the same direction as the tourbillon once it is free to move: the assembly consists of a first epicyclic gear system, in which the tourbillon is the solar train, the outer ring 3 on the ball bearing is a satellite carrier and the reloading wheel 61 is a planetary wheel.

The planetary locking wheel 7 is another planetary wheel fitted so as to pivot on the outer bearing ring. The free movement of the outer ring 3 on the ball bearing is thus locked by the planetary locking wheel 7, comprising a locking pinion 70, with N70 teeth, which meshes with the fixed wheel on the tourbillon 1, while the teeth on the wheel bear on the locking element 21 on the lower cage 2 of the tourbillon (this is therefore a secondary epicyclic gear).

A secondary epicyclic gear system with the fixed wheel 1 on the rotary-cage regulator 200 as the solar train and with the locking pinion 70 on the planetary locking wheel 7 as the planetary wheel, is thus superimposed on the first epicyclic gear system for the reloading wheel 61, the two systems sharing a common satellite carrier, namely the outer ring on the ball bearing 3.

The mechanism functions according to the sequence described below.

The pre-tensioning of the reloading spring 62 in the reloading wheel 61 causes the ball bearing to rotate in the same direction as the tourbillon. This movement is locked by a locking tooth 71 on the planetary locking wheel 7, which rests on the locking element 21 pressed into the lower cage 2 of the rotary-cage regulator 200.

While the tourbillon (more specifically with a one-minute cycle in the non-limiting variant disclosed herein and illustrated by the figures) rotates around its axis, the point of the locking element 21, in particular a pallet stone as can be seen in the figures, goes as far as the point of this locking tooth 71, and the two teeth 22 of the lower cage 2 of the tourbillon continue to rewind the reloading wheel 61.

When the tourbillon has rotated approximately 6° (after one second, or 1/60th of a minute, that is, 1/60th of a turn, for one revolution of the tourbillon per minute), the locking tooth 71 detaches from the locking element 21, and both the planetary locking wheel 7 and the outer ball bearing assembly are then free to rotate around their respective axes.

This rotation is driven by the planetary reloading wheel 61, and stops when the next locking tooth 71 on the planetary locking wheel 7 touches the locking element 21, and the cycle begins again.

In the proposed, non-limiting version of the mechanism, the tourbillon balance oscillates at a frequency of 3 Hz (that is, 21,600 vibrations per hour), the escapement wheel 4 has 15 teeth and its escapement pinion 40 comprises 7 teeth; the planetary locking wheel 7 has 5 teeth and its locking pinion 70 comprises 7 teeth, while the fixed seconds wheel has 84 teeth.

The tourbillon cage itself therefore advances by 6 jumps per second (that is, 3 teeth on the escapement wheel 4) with 1° of rotation per jump; consequently, the escapement wheel 4 rotates around its axis in 5 seconds (5 seconds=15 teeth on the escapement wheel 4, that is, 3 teeth on the escapement wheel per second); likewise for the planetary locking wheel 7, since the gear ratio between its locking pinion 70 and the fixed tourbillon wheel 1 is the same as that of the escapement wheel 4.

With a planetary locking wheel 7 comprising 5 teeth, the ball bearing jumps in one-second increments.

A seconds hand 10, 101, fastened to the outer ring on the ball bearing 3 therefore indicates the jumping seconds (or dead-beat seconds).

Given that the pinions, respectively the escapement pinion 40 on the escapement wheel 4 and the locking pinion 70 on the planetary locking wheel 7, mesh with the same fixed wheel 1 on the tourbillon, and that the position of the locking element 21 is fixed relative to the axis of the escapement wheel 4, the respective angular orientation of their wheel and pinion teeth defines the locking depth of the teeth on the planetary locking wheel 7 on the locking element 21.

Neither setting the position of the pallet stone 21 in the lower cage of the tourbillon, nor orienting the wheels and pinions on the escapement wheel 4 and on the planetary locking wheel 7, in order to obtain a locking depth of approximately 5.5° after the seconds jump, seems very practical, given the unavoidable tolerances and required ease of assembly, as well as after-sales constraints.

Accordingly, the invention proposes the following procedure for precisely adjusting the relative positions of the planetary locking wheel 7 and the locking element 21 on the lower cage 2 of the tourbillon, that is, for adjusting the bolting depth of the locking teeth 71 on the planetary locking wheel 7 on the locking element 21.

In a first step A, random riveting of the escapement wheel 4, on one hand, and of the planetary locking wheel 7, on the other hand, is carried out on their respective pinions, the escapement pinion 40 and the locking pinion 70, without taking account of their angular orientation; the positioning of the locking element 21 is set to within ±1° of its correct theoretical position (using an optical comparator or a gauge, or the like) and this locking element 21 or this locking pallet stone is fastened to the lower cage 2 of the tourbillon.

In a second step B, the mechanism is assembled (without the balance 60 or the upper tourbillon cage 11), the escapement wheel 4 and the planetary locking wheel 7 of the jump seconds mechanism are randomly positioned, and the main spring on the movement is wound.

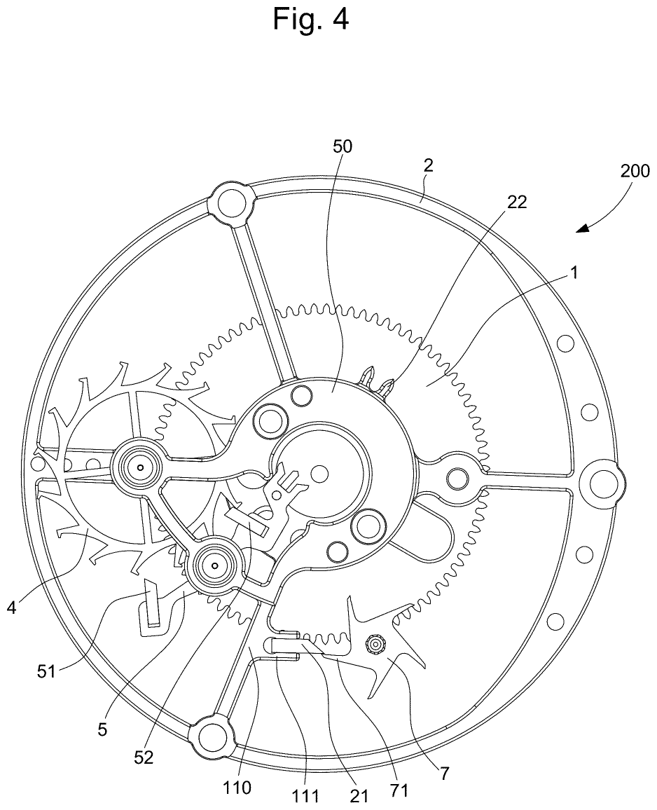

The tourbillon carriage is advanced (in increments of 1°), by manually moving the escapement element 5 back and forth until the locking tooth 71 on the planetary locking wheel 7 reaches the distal end of the locking element 21 as seen in FIG. 4, just before it drops and thus releases the jump seconds mechanism.

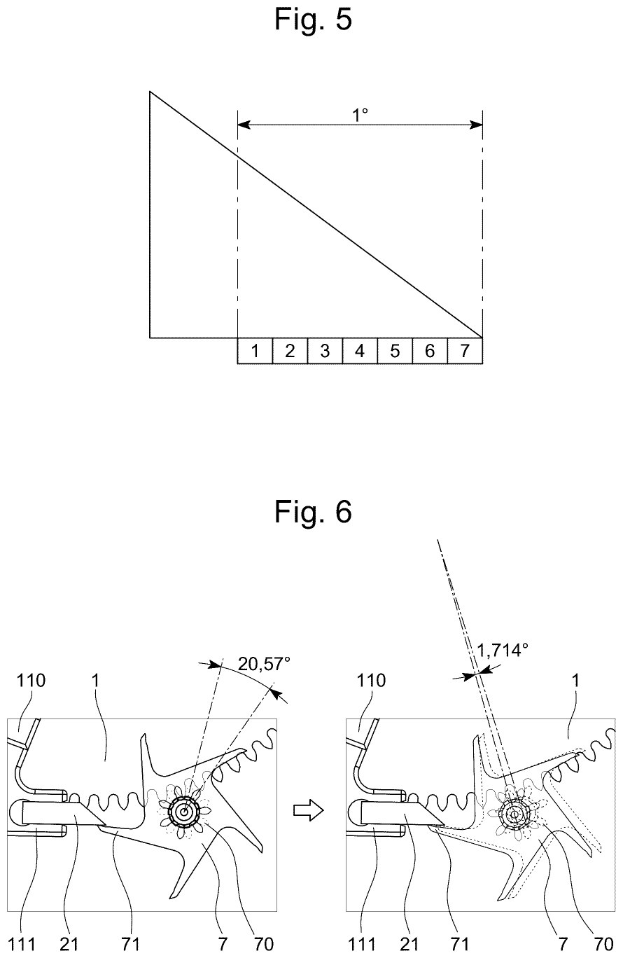

In a third step C, at this stage the point on the locking tooth 71 on the planetary locking wheel 7 is checked to ensure that it is in one of the positions marked on the locking pallet stone, particularly one of the positions numbered “1” to “7” in FIG. 5, in which an angular spacing of 1° is blanked into seven relative positions of the locking tooth 71 relative to the locking element 21, and this position is identified. It is advantageous to be able to adjust, using a suitable setting, the relative position between the locking tooth 71 and the locking element 21.

A fourth step D is devoted to this adjustment setting. When the movement of the outer ring on the ball bearing is temporarily locked (for example by wedging a piece of paper between the movement plate and the ball bearing), the planetary locking wheel 7 can be disengaged and repositioned in accordance with an instruction chart or table such as the one shown below, after rotating the rotary-cage regulator 200 accordingly by again manually moving the escapement element 5 back and forth for the required number of steps. For example, with a locking depth of “5”: disengage the planetary locking wheel 7, rotate the tourbillon through five supplementary escapement steps and reinstall the planetary locking wheel 7 rotated by an angle corresponding to three planetary locking wheel 7 teeth in the clockwise direction, positioned in the first angular degree on the locking element 21 on the tourbillon.

Such a table, which is not limiting and corresponds to the mechanism illustrated in the figures, with specific numbers of teeth for the various mobiles, and very specific oscillation frequencies f0 and jump frequencies fj, and corresponding to the configuration of its escapement mechanism and that of its locking wheel, is provided here, according to a calculation method explained below:
Sector No. 1, locking depth of “1”: 9 escapement steps, no teeth on the planetary locking wheel 7;
Sector No. 2, locking depth of “2”: 2 escapement steps, 1 tooth on the planetary locking wheel 7;
Sector No. 3, locking depth of “3”: 7 escapement steps, 4 teeth on the planetary locking wheel 7;
Sector No. 4, locking depth of “4”: no escapement steps, no teeth on the planetary locking wheel 7;
Sector No. 5, locking depth of “5”: 5 escapement steps, 3 teeth on the planetary locking wheel 7;
Sector No. 6, locking depth of “6”: 10 escapement steps, 1 tooth on the planetary locking wheel 7;
Sector No. 7, locking depth of “7”: 3 escapement steps, 2 teeth on the planetary locking wheel 7.

A fifth step E is used to check that the locking tooth 71 on the planetary locking wheel 7 now has a desired, or even ideal, locking depth (sector no. 4) on the locking element 21 on the tourbillon. If this is not the case, repeat steps C and D until the desired locking depth is reached.

A sixth step F consists of setting the pre-tensioning of the reloading spring 62 on the reloading wheel 61 to the lowest level necessary to obtain a net second jump. Any excessive pre-tensioning will in fact reduce the amplitude of the balance 60. To do so, the reloading wheel 61 can be reinstalled with another pair of teeth in contact with the teeth 22 on the lower cage of the tourbillon 2, specific to the invention.

This method of fine-tuning the locking depth is based on the principle of the Vernier scale: with the position of the tourbillon fixed and one tooth on the planetary locking wheel 7 in contact with the locking element 21, the planetary locking wheel 7 is rotated clockwise by one tooth around its axis, by the value of the quotient of 360° by the number of teeth N7 on the locking wheel 7, in this example 5 teeth, in other words, by the value 360°/5=72°.

The locking pinion 70 on the planetary locking wheel 7 comprises N70=7 teeth.

While the relative orientation of the locking wheel 7 with respect to the imaginary line between its own centre and the centre of the fixed wheel 1 on the tourbillon remains identical (except that it is offset by exactly one tooth in a clockwise direction), the locking teeth 71 on the locking pinion 70 on the locking wheel 7 are inclined by the difference between the values of the quotients of 360° by the number of teeth, on one hand the number of teeth N7 on the planetary locking wheel 7, in this example 5 teeth, and on the other hand the number of teeth N70 on the locking pinion 70 on the locking wheel 7, in this example 7 teeth, this difference has the value (360°/5−360°/7), that is, (72°−51.4286°)=144/7°=20.5714° relative to their original orientation (see FIG. 6, on the left).

The locking pinion 70 on the planetary locking wheel 7 must therefore be moved along the fixed wheel 1 on the tourbillon in order to restore correct meshing between its own teeth and the teeth on the fixed wheel (see FIG. 6, on the right).

With a gear ratio of 7/84=1/12 between the fixed wheel 1 on the tourbillon (comprising N1=84 teeth) and the locking pinion 70 (comprising N70=7 teeth) on the planetary locking wheel 7, this rotation of 20.5714° of the locking pinion 70 around its axis corresponds to a pivot of (20.5714° * 1/12)=144/7° * 1/12=12/7°=1.71429° around the central axis of the tourbillon, as can be seen in FIG. 6, on the right.

To sum up, removing the planetary locking wheel 71 and reinstalling it with a clockwise rotation of one tooth causes the contact point between the point of the locking tooth 71 on the locking wheel 7 and the locking element 21 (represented by a ruby pallet stone in FIGS. 4, 5 and 6), moves by the angular value of 1.71429°=(360°/5−360°/7)*7/84 in a clockwise direction (and therefore drops deeper onto the locking element 21). If the planetary locking wheel 7 is turned not by one but by two teeth before it is installed, the corresponding tooth on the locking wheel drops by the angle 2*1.714290=3.42857° lower onto the locking element 21. Accordingly, depending on the number X of teeth by which the planetary locking wheel 7 is rotated before being reinserted, the following theoretical modifications are obtained in the locking depth Δ/rotation of the locking wheel around the fixed seconds wheel, with Δ=X*1.71429°=X*12/7°:
X=1, Δ=1.71429°=12/7;
X=2, Δ=3.42857°;
X=3, Δ=5.14286°;
X=4, Δ=6.85714°;
X=5, Δ=8.57143°;
X=6, Δ=10.28571°;
X=7, Δ=12°.

However, when the escapement is released once, the locking element 21 in turn moves by 360°/(84/7*15*2)=1°, in a clockwise direction (because the fixed tourbillon wheel 1 or seconds wheel has 84 teeth, the escapement pinion 40 on the escapement wheel 4 has 7 teeth, and the escapement wheel 4 has 15 teeth; each time the escapement is released, the escapement wheel 4 rotates by half a tooth due to the Swiss pallet escapement 5 used, with 2 impulses per complete oscillation), hence the factor 2.

As a result, the locking depth Δ of the locking tooth 71 on the planetary locking wheel 7 on the pallet stone 21 on the tourbillon cage 2 can be reduced by 1° per escapement step.

To modify the locking depth by only a few fractions of a degree, the escapement can be released by a corresponding number of steps, as follows, wherein Δ is the locking depth with no supplementary escapement steps, wherein N is the number of supplementary escapement steps, and wherein ΔM is the locking depth modified with this corresponding number N of supplementary escapement steps:
X=1, Δ=1.71429°; N=1, ΔM=1.71429° mod 1°=0.71429°=5/7°;
X=2, Δ=3.42857°; N=3, ΔM=3.42857° mod 1°=0.342857°=3/7°;
X=3, Δ=5.14286°; N=5, ΔM=5.14286° mod 1°=0.14286°=1/7°;
X=4, Δ=6.85714°; N=6, ΔM=6.85714° mod 1°=0.85714°=6/7°;
X=5, Δ=8.57143°; N=8, ΔM=8.57143° mod 1=0.57143°=4/7°;
X=6, Δ=10.28571°; N=10, ΔM=10.28571° mod 1°=0.285714=2/7°;
X=7, Δ=12°; N=12, ΔM=12° mod 1°=0°=0/7°.

Or N=1=1.71429° div 1°, N=3=3.42857° div 1°, and so on.

Otherwise expressed,
N=1=12/7° div 1°
N=3=24/7° div 1°
N=5=36/7° div 1°
N=6=48/7° div 1°
N=8=60/7° div 1°
N=10=72/7° div 1°
N=12=84/7° div 1°
or in general:
Δ=X*12/7°
N=Δ div 1°
ΔM=Δ mod 1°

As a result, an appropriate combination of rotating the planetary locking wheel 7 prior to repositioning it and the supplementary release of an appropriate number of escapement steps makes it possible to modify the locking depth in steps of 1/7°, because, as the jump mechanism is released within one escapement step and the corresponding 1° rotation of the tourbillon cage and the locking element 21 fastened thereto, the locking tooth 71 on the planetary locking wheel 7 can now be in one of the seven positions shown in FIG. 5, during the last half-oscillation before the jump is released.

The “4” median position is preferred, as it offers a sufficient safety margin against premature or late release in the event of concentricity deviation/toothing inaccuracy/or any geometric defect.

However, depending on the random orientation of the components during assembly, the horologist may find another of the positions (1-3 or 5-7). By removing the planetary locking wheel 7 again, advancing the escapement by a defined number of steps, and reinserting the planetary locking wheel 7 rotated by a defined number of teeth, state “4” should now be reached. This can be achieved from state ‘5,’ for example, by inducing a rotation of 1/7°, which can be achieved (as can be seen in the table above) by N=5 supplementary escapement steps and a repositioning of the planetary locking wheel 7 rotated by X=3 teeth.

This results in the following correspondence between sectors 1 to 7 and the above table, with the last value Y indicating correspondence to the referenced sector, that is, the required position in FIG. 5:
X=1, Δ=1.71429°; N=1, ΔM=1.71429° mod 1°=0.71429°=5/7°; Y=2*;
X=2, Δ=3.42857°; N=3, ΔM=3.42857° mod 1°=0.342857°=3/7°;
Y=7;
X=3, Δ=5.14286°; N=5, ΔM=5.14286° mod 1°=0.14286°=1/7°; Y=5;
X=4, Δ=6.85714°; N=6, ΔM=6.85714° mod 1°=0.85714°=6/7°; Y=3*;
X=5, Δ=8.57143°; N=8, ΔM=8.57143° mod 1°=0.57143°=4/7°; Y=1*;
X=6, Δ=10.28571°; N=10, ΔM=10.28571° mod 1°=0.285714=2/7°;
Y=6;
X=7, Δ=12°; N=12, ΔM=12° mod 1°=0°=0/7°; Y=(4).

However, for the Y=1 to 3 sectors (marked with an *: 1*, 2*, 3*), a procedure according to the table above would mean that the jump would only take place two escapement steps later, so a supplementary escapement step must be taken into account here. Moreover, the planetary locking wheel 7 has only N7=5 teeth; a rotation of 5 teeth therefore corresponds to the starting position, such that the actual rotation can be dispensed with (similarly, rotating 6 teeth corresponds to rotating 1 tooth, rotating 7 teeth corresponds to rotating 2 teeth, and therefore X modulo 5 leads to the same result as rotating X).

This results, for example, in the following easy-to-follow instructions for the horologist who is setting the mechanism: sector number Y, number X of teeth on the satellite planetary locking wheel 7 to be turned clockwise, number N of supplementary escapement steps:
Y=1, X=0, N=9;
Y=2, X=1, N=2;
Y=3, X=4, N=7;
Y=4, X=0, N=0;
Y=5, X=3, N=5;
Y=6, X=1, N=10;
Y=7, X=2, N=3.

Rotating the planetary locking wheel 7 by several teeth X will therefore lead to a new position of the planetary locking wheel 7 of (X*1.71429°) relative to the original position (in a clockwise direction around the axis of the tourbillon). And the tangential displacement of the point on the locking tooth 71 on the planetary locking wheel 7 along the pallet stone 21 corresponds substantially to this value.

And since manually moving the escapement element 5 from one rim to the other causes the entire tourbillon to jump in increments of 1° (one-minute tourbillon, 6 jumps per second, 60 seconds per minute=360 jumps of 1°), the position of the distal end of the 71 tooth on the planetary locking wheel 7 relative to the locking element 21 can be adjusted to (X*1.71429°) modulo 1°, that is, in increments of 1/7°, which leads to the rules described above for defining the adjustment table.

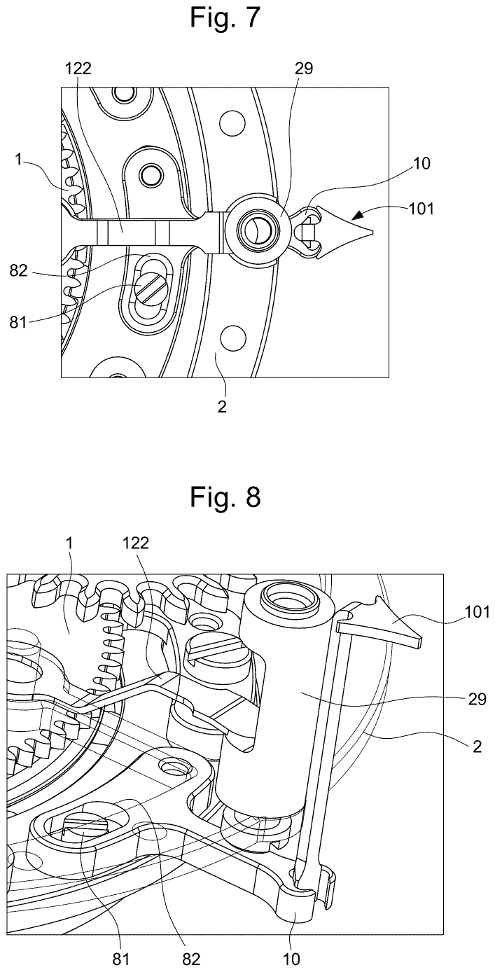

To adjust the relative position of the seconds hand and of the lower cage 2 on the tourbillon, the support 10 for the seconds hand 101 can be adjusted by sliding it over a constant radius, before screwing it onto the outer ring 3 on the ball bearing, so that it coincides exactly with the pillar 29 on the tourbillon when the seconds jump occurs, as can be seen in FIGS. 7 and 8. Adjusting and fastening are advantageously achieved by the combination of a shoulder screw 81 and an oblong counterbore 82.

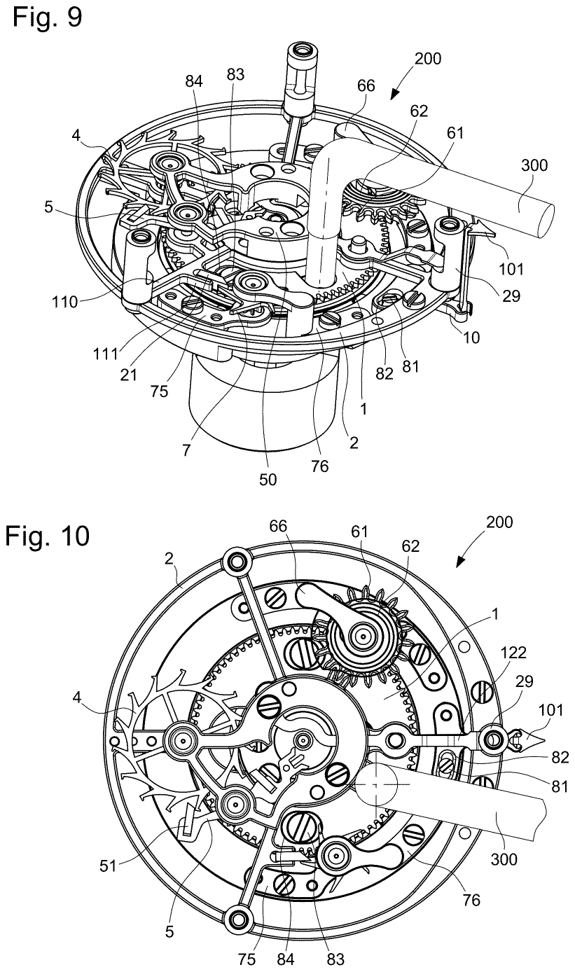

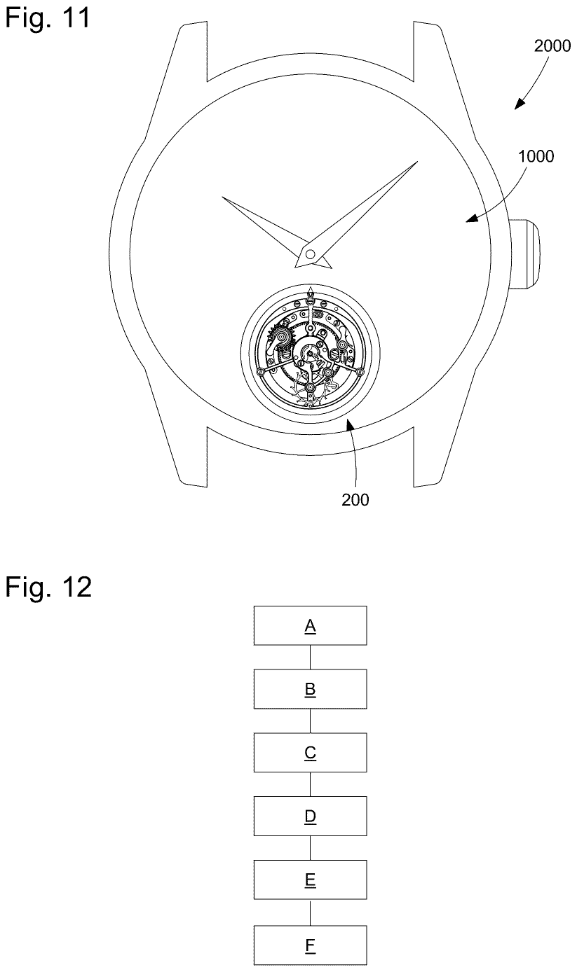

To ensure that the seconds hand is exactly aligned with the seconds indexes on the dial, the rotation of the fixed wheel 1 on the rotary-cage regulator 200 can be set relative to the seconds dial, for example as proposed by oblong holes 84 around its fastening screws 83 and a blank 85 enabling an eccentric tool 300 to be used to fine-tune the position, as can be seen in FIGS. 9, 10 and 11.

To sum up, the invention offers an improvement on the jumping seconds mechanisms in the prior art, particularly in that, instead of functioning on the known principle of the remontoir d'égalité, the mechanism according to the invention operates outside the flow of energy between the barrel and the escapement, which considerably reduces the stresses induced on its parts.

More specifically, the tourbillon in the mechanism of the invention is a flying tourbillon.

In the present embodiment of the invention, it should be noted that the reloading spring that drives the proposed second jump mechanism is not located on the same axis as the tourbillon, but on a planetary wheel placed on the ball bearing of the jump mechanism. This makes it possible to use the mechanism described in document CH717982 granted to GLASHUETTE ORIGINAL, Glashütter Uhrenbetrieb GmbH, to stop the balance 60 on the tourbillon when setting the hour and minute hands. This mechanism also makes it easy to adjust the pre-tensioning of the spring by simply assembling it with another pair of teeth in contact with the tourbillon gear.

Moreover, the compact layout of the invention makes use of the otherwise empty space beneath the tourbillon cage, and the entire mechanism is also fully visible through the existing opening in the dial on the flying tourbillon. The modular nature of the invention makes it possible to apply it to existing movements with a minimum of adjustments.

By varying the number of teeth on the planetary locking wheel, the mechanism can also be easily modified to jump at intervals of other values, for example at half-second intervals (by doubling the number of teeth on the planetary locking wheel), similar to a marine chronometer.

The mechanism according to the invention can also be used by varying certain parameters, in particular the frequency f0 of the oscillator and number of teeth (always an integer) on the various pinions and wheels on the mechanism: the number of teeth te or N4 on the escapement wheel 4, the number of teeth tpe or N40 on the escapement pinion 40 on the escapement wheel 4, the number of teeth ttf or N1 on the fixed tourbillon wheel 1, the number of teeth tpb or N70 on the locking pinion 70 on the locking wheel 7, and the number of teeth tb or N7 on the locking wheel 7, given that the desired jump frequency fj must meet the following two conditions.
First condition: fj=((tpe*tb)/tpb)*f0/(te), or, with the numbers of teeth replaced by the references of their mobiles,
fj=((N40*N7)/N70)*(f0/N4)
Second condition: the ratio f0/(0.5*fj) is an integer.

In this way, and without limitation, the following mechanisms would also work:
First example: fj=2 Hz, f0=4 Hz, te=20, tpe=10, tpb=16, tb=16, or, with the numbers of teeth replaced by the references of their mobiles, N4=20, N40=10, N70=16, N7=16.
Second example: fj=4/3 Hz, f0=4 Hz, te=20, tpe=12, tpb=9, tb=5, or, with the numbers of teeth replaced by the references of their mobiles, N4=20, N40=12, N70=9, N7=5, configuration which therefore results in a jump of 3/4 of a second.

Remember that the particular variant illustrated by the figures corresponds to the values: fj=1 Hz, f0=3 Hz, te=15, tpe=7, tpb=7, tb=5, or, with the numbers of teeth replaced by the references of their mobiles, N4=15, N40=7, N70=7, N7=5.

If the tourbillon is supposed to make one revolution in one minute (that is, give a true seconds display of 60 seconds per 360° revolution), the following supplementary condition must apply:
ttf=60*(tpe*f0)/te is an integer, or, with the number of teeth replaced by the mobile references, ttf=N1=60*(N40*f0)/N4, is an integer.

The proposed arrangement of a reloading planetary wheel can also be used to apply other dead-beat seconds mechanisms to the aforementioned flying tourbillon according to CH717982A2, which would usually require a coaxially fitted balance spring to accumulate the necessary jump energy or a secondary kinematic chain, such as secondary pallet escapement mechanisms, like the ones used by Jaquet Droz, or others.

For this class of mechanism, the lower cage of the tourbillon can be used as the drive wheel of the pallet, and the outer ring of the ball bearing with the planetary reloading wheel as the jump seconds wheel.

The invention also relates to a watch 2000 comprising at least one such movement 1000.

The invention also relates to a horology assembly comprising at least one such watch 2000 and/or one such movement 1000. This horology assembly comprises, for each type of movement 1000 or of calibre, a table for the horologist at the works or in the after-sales department, said table listing the number X of teeth on the planetary locking wheel 7 to be rotated in a clockwise direction, and the number N of supplementary escapement steps to be carried out on the escapement element 5, in order to obtain a predetermined lock position for the locking tooth 71 on the locking element 21.

In particular, for the specific example described in this description, wherein: fj=1 Hz, f0=3 Hz, te=15, tpe=7, tpb=7, tb=5, or, with the numbers of teeth replaced by the references of their mobiles, N4=15, N40=7, N70=7, N7=5, the parameters for the number X of teeth on said satellite planetary locking wheel 7 to be rotated in the clockwise direction, and for the number N of supplementary escapement steps to be carried out on the escapement element 5, are as follows: for a division of an angle at the centre of 1° on said locking element (21) or said locking pallet stone into seven lock positions for said locking tooth (71) referred to as sector No. 1 to sector No. 7, with sector No. 1, locking depth of “1”, 9 escapement steps, no teeth on the planetary locking wheel 7, with sector No. 2, locking depth of “2”, 2 escapement steps, 1 tooth on the planetary locking wheel 7, with sector No. 3, locking depth of “3”, 7 escapement steps, 4 teeth on the planetary locking wheel 7, with sector No. 4, locking depth of ‘4’, no escapement steps, no teeth on the planetary locking wheel 7, with sector No. 5, locking depth of ‘5’, 5 escapement steps, 3 teeth on the planetary locking wheel 7, with sector No. 6, locking depth of ‘6’, 10 escapement steps, 1 tooth on the planetary locking wheel 7, and with sector No. 7, locking depth of ‘7’, 3 escapement steps, 2 teeth on the planetary locking wheel 7.

1. A mechanical horology movement (1000) comprising at least one rotary-cage regulator (200) comprising a fixed wheel (1), a cage carrying a sprung balance, an escapement element (5), an escapement wheel (4) and a locking element (21), as well as a bearing fastened to a plate of said movement (100) coaxially with the cage,
wherein the rotary-cage regulator (200) comprises a locking wheel (7) with locking teeth (71) pivoting on a ring (3) of said bearing and said locking teeth (71) being able to be stopped by said locking element (21) with a lock position that can be set in the workshop,
wherein said locking wheel (7) is arranged to release or lock the movement of said ring (3) and carries a locking pinion (70) permanently meshing with said fixed wheel (1), and
wherein said ring (3) is connected to the rotary-cage regulator (200) by an intermediate reloading system, which arms a reloading spring (62) through the movement of said rotary-cage regulator (200) so that said reloading spring (62) keeps said ring (3) moving in the same direction of rotation as the rotary-cage regulator (200) as it lets down.

2. The movement (1000) according to claim 1, wherein the escapement pinion (40) meshes with said fixed wheel (1), and wherein said intermediate reloading system consists of a lower cage (2) comprised in said cage and which carries gear teeth (22) and a reloading wheel (61) attached to said reloading spring (62) and pivoting on said ring (3) and meshing with said gear teeth (22) on said lower cage (2), and wherein the assembly consisting of said lower cage (2), said reloading wheel (61) and its said reloading spring (62), said ring (3), said locking wheel (7) and said locking element (21), constitutes a first epicyclic gear system, in which said lower cage (2) is the solar train, said ring (3) is a satellite carrier, in which said reloading wheel (61) is a first planetary gear, and in which said locking wheel (7) is a second planetary gear.

3. The movement (1000) according to claim 2, wherein said reloading spring (62) on said reloading wheel (61) is rewound by the movement of said cage (2), said bearing being immobile, via the meshing between said teeth (22) on said lower cage (2) and said reloading wheel (61), and wherein, when said lower cage (2) pivots around its pivot axis (DP), the point of said locking element (21) is mobile up to the point of a said locking tooth (71) that bears on said locking element (21).

4. The movement (1000) according to claim 1, wherein said fixed wheel (1) is fastened to a plate on said movement (1000) and comprises an outer toothing, wherein said gear teeth (22) are outwardly protruding, wherein said reloading wheel (61) is pivoted in a first cock (66) and is associated with said reloading spring (62) attached at its ends to said first cock (66) and to said reloading wheel (61), and wherein said planetary locking wheel (7) is pivoted in a second cock (76), wherein said reloading wheel (61) and said planetary locking wheel (7) are fitted so as to pivot apart from each other on said ring (3) which is an outer ring of said ball bearing, said reloading spring (62) being, when said outer ring (3) is immobile, reloaded by the movement of said rotary-cage regulator (200) via the meshing between said teeth (22) and said reloading wheel (61), and the tension of said reloading spring (62) enabling said outer ring (3), once released, to rotate in the same direction as said rotary-cage regulator (200), and wherein said locking teeth (71) are arranged to bear on said locking element (21) or said locking pallet stone.

5. The movement (1000) according to claim 2, wherein said rotary-cage regulator (200) comprises a second secondary epicyclic gear system of which said fixed wheel (1) is the solar train, said outer ring (3) a satellite carrier, and said locking pinion (70) a planetary gear, said second secondary epicyclic gear system being superimposed on the first epicyclic gear system by adding the satellite carrier consisting of said outer ring (3).

6. The movement (1000) according to claim 1, wherein said rotary-cage regulator (200) is a jumping-seconds flying tourbillon, the jump frequency fj of which is determined by the formula fj=((N40*N7)/N70)*(f0/N4), wherein N40 is the number of teeth on said escapement pinion (40), N7 is the number of teeth on said locking wheel (7), N70 is the number of teeth on said locking pinion (70), f0 is the frequency of the oscillator consisting of said sprung balance, and N4 is the number of teeth on said escapement wheel (4), and further wherein the ratio f0/(0.5*fj) is an integer.

7. The movement (1000) according to claim 1, wherein said locking element (21) or said locking pallet stone comprises a support surface, which can engage with each said locking tooth (71), and which extends, in a plane perpendicular to the pivot axis of said cage (2), in a substantially tangential direction relative to a bed (111) in which said locking element (21) is inserted and fastened, and wherein the jump instant can be set by setting the relative tangential position between said locking element (21) and each said locking tooth (71), corresponding to a lock position of said locking tooth (71).

8. The movement (1000) according to claim 7, wherein said lock position can be set to a locked position of said ring (3) by moving said escapement element (5) by a predetermined number N of escapement steps, and by rotating said planetary locking wheel (7) by an angle corresponding to a predetermined number X of teeth on said planetary locking wheel (7).

9. The movement (1000) according to claim 8, wherein each said locking tooth (71) is arranged to assume, in increments, an integral number of discrete lock positions over the depth of said locking element (21), each referenced by a sector number Y, and reachable according to a table indicating said number X of teeth on said satellite planetary locking wheel (7) to be rotated in a clockwise direction, and said number N of supplementary escapement steps to be carried out on said escapement element (5) or said pallet.

10. The movement (1000) according to claim 7, wherein each said locking tooth (71) is arranged to occupy, relative to said locking element (21), lock positions within a predetermined angular interval, relative to said pivot axis of said cage (2), corresponding to an integer number of degrees.

11. The movement (1000) according to claim 7, wherein said escapement pinion (40) and said locking pinion (70) mesh with the same said fixed wheel (1), wherein the position of said locking element (21) is fixed relative to the pivot axis of said escapement wheel (4), and wherein the locking depth of the teeth on said planetary locking wheel (7) on said locking element (21) is defined by the respective angular orientation of the teeth on said escapement pinion (40) and on said locking pinion (70).

12. The movement (1000) according to claim 7, wherein the frequency f0 of the oscillator, and the integer number of teeth on the various pinions and wheels of the mechanism, that is, the number of teeth N4 on said escapement wheel (4), the number of teeth N40 on said escapement pinion (40), the number of teeth N1 on said fixed wheel (1), the number of teeth N70 on said locking pinion (70), and the number of teeth N7 on said locking wheel (7), are such that the desired jump frequency fj meets a first condition in which fj=((N40*N7)/N70)*(f0/N4), and a second condition in which the ratio f0/(0.5*fj) is an integer.

13. The movement (1000) according to claim 12, wherein fj=1 Hz, f0=3 Hz, N4=15, N40=7, N70=7, N7=5, for one jump per second.

14. The movement (1000) according to claim 12, wherein fj=2 Hz, f0=4 Hz, N4=20, N40=10, N70=16, N7=16, for one jump per half second.

15. A watch (2000) comprising at least one movement (1000) according to claim 13.

16. A horology assembly comprising a watch according to claim 15, wherein said horology assembly comprises, for each type of said movement (1000) or of calibre, a table for the use of the horologist at the works or in the after-sales department, said table listing the number X of teeth on said satellite planetary locking wheel (7) to be rotated in the clockwise direction, and the number N of supplementary escapement steps to be carried out on said escapement element (5), in order to arrive at a predetermined lock position of said locking tooth (71) on said locking element (21).

17. The horology assembly according to claim 16 comprising the movement, comprising, as parameters of said number X of teeth of said satellite planetary locking wheel (7) to be rotated in the clockwise direction, and of said number N of supplementary escapement steps to be carried out on said escapement element (5), for a division of an angle at the centre of 1° on said locking element (21) into seven lock positions of said locking tooth (71) referred to as sector No. 1 to sector No. 7, with sector No. 1, locking depth of “1,” 9 escapement steps, no teeth on the planetary locking wheel 7, with sector No. 2, locking depth of “2,” 2 escapement steps, 1 tooth on the planetary locking wheel 7, with sector No. 3, locking depth of “3,” 7 escapement steps, 4 teeth on the planetary locking wheel 7, with sector No. 4, locking depth of “4,” no escapement steps, no teeth on the planetary locking wheel 7, with sector No. 5, locking depth of “5,” 5 escapement steps, 3 teeth on the planetary locking wheel 7, with sector No. 6, locking depth of “6,” 10 escapement steps, 1 tooth on the planetary locking wheel 7, and with sector No. 7, locking depth of “7,” 3 escapement steps, 2 teeth on the planetary locking wheel 7.

18. A method for adjusting the precision of the relative positions of said planetary locking wheel (7) and of said locking element (21) in a horology assembly according to claim 16, by adjusting the bolting depth of the locking teeth (71) on the planetary locking wheel (7) on said locking element (21), said method comprising a first step (A) in which said escapement wheel (4) is randomly riveted to its said escapement pinion (40), on one hand, and said planetary locking wheel (7) is randomly riveted to its said locking pinion (70), said first step (A) comprising setting the positioning of said locking element (21) to ±1° of its correct theoretical position and fastening it to said cage (2), a second step (B) in which the mechanism is assembled without a balance on said sprung balance nor an upper cage comprised in said rotary-cage regulator (200), with random positioning of said escapement wheel (4) and of said planetary locking wheel (7) in the seconds-jump mechanism, and rewinding the main spring of the movement, said second step (B) comprising the incremental gain of 1° of said cage (2), by manually moving said escapement element (5) back and forth, until said locking tooth (71) reaches the distal end of said locking element (21), just before it drops and thereby releases the seconds-jump mechanism, a third step (C) in which the point of said locking tooth (71) is checked to ensure that it is in one of the positions marked on said locking element (21), on which an angular deviation of 1° is blanked in an integer number of relative positions of said locking tooth (71) relative to said locking element (21) and this position is identified, a fourth step (D) in which the adjustment is set, by temporarily locking said ring (3), countersinking said planetary locking wheel (7) and repositioning it in accordance with said instruction table after rotating said cage (2) by manually moving said escapement element (5) back and forth again for the required number of steps, a fifth step (E) in which the locking depth of said locking tooth (71) is checked and, if the desired locking depth is not reached, said third step (C) and said fourth step (D) are repeated iteratively until the desired locking depth is reached.

19. The adjustment method according to claim 18, comprising a sixth step (F) in which the pre-tensioning of said reloading spring (62) on said reloading wheel (61) is set to the lowest level necessary to obtain a net second jump.

20. The adjustment method according to claim 19, said sixth step (F) comprising reinstalling said reloading wheel (61) with another pair of teeth in contact with said teeth (22) on said cage (2).

21. The adjustment method according to claim 18, in which, in said third step (C), the relative position between said locking tooth (71) and said locking element (21) is adjusted by a suitable setting.

22. The adjustment method according to claim 18, in which, in order to adjust the relative position of a seconds hand (101) and of said tourbillon cage (2), a support (10) for said seconds hand (101) is adjusted by sliding it over a constant radius, before it is screwed onto said ring (3), so as to coincide exactly with a pillar (29) comprised in said rotary-cage regulator (200) when the seconds jump takes place.

23. The adjustment method according to claim 18, in which, in order to ensure accurate alignment on a seconds index of a dial, said fixed wheel (1) is rotationally set relative to a seconds dial by oblong holes around its fastening screws and a blank enabling an eccentric tool (300) to be moved in order to fine-tune the position.
